(19) United States
(12) Patent Application Publication
(10) Pub. No.: US 2026/0270620 A1
(43) Pub. Date: Sep. 10, 2026

(54) LOUDSPEAKER AND METHOD OF MANUFACTURING LOUDSPEAKER

(71) Applicant: ALPS ALPINE CO., LTD., Tokyo (JP)

(72) Inventor: Hiroki TOITA, Fukushima (JP)

(21) Appl. No.: 19/549,556

(22) Filed: Feb. 25, 2026

(30) Foreign Application Priority Data
Mar. 6, 2025 (JP) 2025-035166

(51) Int. Cl. H04R 9/02; H04R 9/06

(52) U.S. Cl. CPC H04R 9/025; H04R 9/06

(57) ABSTRACT

A loudspeaker includes: a diaphragm having a first end attached to a frame and a second end attached to a bobbin; magnetic circuitry arranged in a vicinity of the bobbin; a first magnet to vibrate the diaphragm based on a voice signal applied to a voice coil; a second magnet fixed to a rear surface of the first end of the diaphragm; a magnetic detector; a third magnet; and a holder to hold the magnetic detector and the third magnet. The holder is fixed to the frame to be positioned with respect to the second magnet by using a positioning portion used to fix the second magnet in place, and the magnetic detector is to detect displacement of the diaphragm based on a first magnetic field generated by the second magnet and a second magnetic field generated in a direction different from the first magnetic field by the third magnet.

### CROSS-REFERENCE TO RELATED APPLICATIONS

The present application is based on and claims priority to Japanese Patent Application No. 2025-035166 filed on March 6, 2025, the entire contents of which are hereby incorporated by reference.

### BACKGROUND

### 1. Field of the Invention

The present disclosure relates to a loudspeaker which detects the operation of a vibrating portion including a diaphragm with high accuracy by a magnetic sensor.

### 2. Description of the Related Art

Conventional loudspeakers only passively process the output of an amplifier at all times. Among acoustic equipment, the loudspeakers exhibits the greatest distortion, and can be damaged when driven at excessive amplitudes. To solve the above issue, Japanese Laid-Open Patent Application No. S57-184397 discloses a loudspeaker which detects a moving state of a vibrating portion including a diaphragm and performs feedback control. According to the above disclosure, a Hall element is provided on a portion of a plate included in magnetic circuitry to face a voice coil. A magnetic flux density in a magnetic gap in the magnetic circuitry is detected by the Hall element, a detection result is fed back to the amplifier, and a drive current applied to the voice coil is controlled to correct the distortion.

### SUMMARY

Disclosed is a loudspeaker including: a diaphragm having one end attached to a frame and another end attached to a bobbin; magnetic circuitry arranged in a vicinity of the bobbin; a first magnet configured to vibrate the diaphragm based on a voice signal applied to a voice coil; a second magnet fixed to a rear surface of the one end of the diaphragm; a magnetic detector; a third magnet; and a holder configured to hold the magnetic detector and the third magnet. In the loudspeaker, the holder is fixed to the frame to be positioned with respect to the second magnet by using a positioning portion of the frame configured to fix the second magnet in place, and the magnetic detector is configured to detect displacement of the diaphragm based on a first magnetic field generated by the second magnet and a second magnetic field generated by the third magnet in a direction different from the first magnetic field.

Disclosed is a method of manufacturing a loudspeaker including: attaching a diaphragm and magnetic circuitry to a frame, and then attaching a second magnet to a rear surface of the one end of the diaphragm by using a positioning portion of the frame; and attaching a holder configured to hold a magnetic sensor and a third magnet to the frame by using the positioning portion such that the holder is positioned with respect to the second magnet. One end of the diaphragm is attached to the frame and another end of the diaphragm is attached to a bobbin, the magnetic circuitry is arranged in a vicinity of the bobbin, and the loudspeaker includes a first magnet configured to vibrate the diaphragm based on a voice signal applied to a voice coil.

### BRIEF DESCRIPTION OF THE DRAWINGS

FIG. 1A is a schematic cross-sectional diagram illustrating a conventional loudspeaker;

FIG. 1B is a diagram illustrating a magnetic field generated by a first magnet and a second magnet;

FIG. 1C is a graph for explaining a magnetic flux, which is a combined vector Hd of a magnetic flux vector H1 of a magnetic field F1 and a magnetic flux vector H2 of a magnetic field F2;

FIG. 1D is another graph for explaining the magnetic flux;

FIG. 2 is a perspective diagram illustrating a cross section in a Z-direction of a loudspeaker according to an embodiment of the present disclosure;

FIG. 3A is an enlarged schematic cross-sectional diagram illustrating a configuration of a detector configured to detect a displacement of a diaphragm mounted on the loudspeaker according to the embodiment of the present disclosure;

FIG. 3B is a diagram illustrating a configuration of a holder disposed in the loudspeaker of FIG. 3A;

FIG. 3C is a diagram for explaining a magnetic field of a second magnet installed in the loudspeaker of FIG. 3A;

FIG. 3D is a diagram for explaining a magnetization direction of a third magnet mounted in the loudspeaker of FIG. 3A;

FIG. 4A is a diagram for explaining a method of mounting the second magnet;

FIG. 4B is a diagram for explaining a method of mounting a third magnet and a GMR sensor;

FIG. 5A is a graph illustrating a relationship between a displacement of a diaphragm and a magnetic angle in a conventional loudspeaker; and

FIG. 5B is a graph illustrating a relationship between the displacement of the diaphragm and the magnetic angle in the loudspeaker according to the embodiment of the present disclosure.

### DESCRIPTION OF THE PREFERRED EMBODIMENTS

As in Japanese Laid-Open Patent Application No. S57-184397, although it is possible to detect the magnetic flux density by a Hall element and feedback the amplitude of a diaphragm, it is still insufficient as a sensor in view of detection accuracy and minimizing accuracy, noise, and load on a loudspeaker. In contrast to the above, by using a magnetic sensor (for example, a giant magnetoresistance (GMR) sensor) capable of detecting an angle of a magnetic flux and fixing a second magnet smaller than a magnet of the loudspeaker to a vibrating member, development of a loudspeaker capable of detecting displacement of a vibrating portion with high accuracy from an angular change of a combined vector of the magnetic flux is underway.

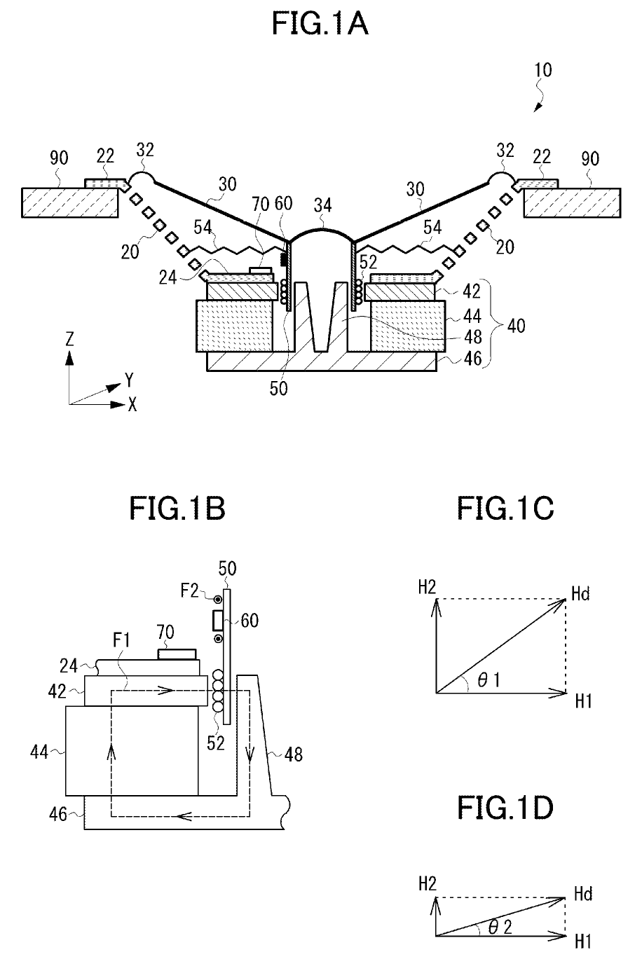

FIG. 1A is a schematic sectional view of a loudspeaker equipped with such a GMR sensor. A loudspeaker 10 includes a frame 20, a diaphragm 30, and magnetic circuitry 40. One end 22 of the frame 20 is attached to a fixing member 90, and the other end 24 is attached to the magnetic circuitry 40. The diaphragm 30 is attached to one end of the frame 20 via a hemispherical edge 32, and a dome-shaped center cap 34 is attached to the center of the diaphragm 30. The magnetic circuitry 40 includes a ring-shaped top plate (opposing yoke) 42, a ring-shaped first magnet 44, a disk-shaped first magnet (rear yoke) 46, a center pole (center yoke) 48 projecting upward from the center portion of the first magnet 46, a cylindrical bobbin 50 arranged outside the center pole 48, and a voice coil 52 wound around the outer periphery of the bobbin 50. The bobbin 50 is connected to the middle of the frame 20 by a damper 54, and the upper end of the bobbin 50 is adhered to the rear surface of the diaphragm 30 by an adhesive.

When a drive current as an audio signal is applied to the voice coil 52, the diaphragm 30 vibrates in a vertical direction of the Z-axis via the voice coil 52 by the action of electromagnetic force with the first magnet 44.

A GMR sensor 70 is fixed to the surface of the other end 24 of the frame 20 in an XY plane, and a second magnet 60 is fixed to an upper portion of the bobbin 50 in a magnetic gap. As shown in FIG. 1B, the first magnet 44 of the magnetic circuitry 40 generates a magnetic field passing through the top plate 42, the center pole 48 and the first magnet 46 from the N pole to the S pole, and a magnetic field F1 thereof passing through the top plate 42 in a radial direction acts on the GMR sensor 70. In contrast to the above, the second magnet 60 is magnetized to generate a magnetic field F2 in a direction perpendicular to the radial direction (a tangential direction of the bobbin 50) in the XY plane, and the magnetic field F2 acts on the GMR sensor 70.

The GMR sensor 70 utilizes a GMR effect in which a resistance value changes under the influence of an external magnetic field. For example, the GMR sensor 70 is driven under bias by a DC voltage or a DC current, and outputs a voltage or a current corresponding to a resistance change when the resistance value changes due to the GMR effect of the external magnetic field. Therefore, when the magnetic field F1 and the magnetic field F2 act on the GMR sensor 70, the GMR sensor 70 detects a resistance value that changes according to the magnitude of the combined magnetic field of the magnetic field F1 and the magnetic field F2.

FIGS. 1C and 1D are graphs each illustrating a magnetic flux that is a combined vector Hd of a magnetic flux vector H1 of the magnetic field F1 and a magnetic flux vector H2 of the magnetic field F2. Since a relative distance between the GMR sensor 70 and the first magnet 44 does not change, the magnetic flux vector H1 of the magnetic field F1 does not substantially change. In contrast to the above, since the relative distance between the second magnet 60 and the GMR sensor 70 changes according to the vibration of the diaphragm 30, the magnetic flux vector H2 of the magnetic field F2 changes accordingly. As the second magnet 60 approaches the GMR sensor 70, the magnetic flux vector H2 increases as shown in FIG. 1C, and the combined vector Hd with an angle θ1 acts on the GMR sensor 70. As the second magnet 60 moves away from the GMR sensor 70, the magnetic flux vector H2 decreases as shown in FIG. 1D, and the combined vector Hd with an angle θ2 acts on the GMR sensor 70. That is, a detection result of the GMR sensor 70 corresponds to the angle of the combined vector Hd, and the angle of the combined vector Hd corresponds to the position of the diaphragm 30. The amplifier receives the detection result fed back from the GMR sensor 70, and generates an audio signal in which distortion is corrected.

In such a conventional loudspeaker, the GMR sensor 70 is disposed around the magnetic circuitry in order to utilize the magnetic field of the magnetic circuitry of the loudspeaker. However, when the audio signal is applied to the voice coil 52, the magnetic field generated by the current flowing through the voice coil 52 acts on the GMR sensor 70, a detection result of the GMR sensor 70 is disturbed, and thus the position or displacement of the diaphragm cannot be accurately detected. In particular, when the displacement of the diaphragm detected differs depending on the difference in the frequency of the audio signal applied to the voice coil, the audio signal cannot be appropriately corrected.

The present disclosure provides a loudspeaker capable of accurately detecting the displacement of the diaphragm and a method of manufacturing the loudspeaker.

Next, an embodiment of the present disclosure will be described. The loudspeaker according to the present embodiment has a function of monitoring the behavior of the diaphragm in real time. In the conventional case, the GMR sensor is installed around the magnetic circuitry in order to utilize the magnetic field of the magnetic circuitry of the loudspeaker. However, in this configuration, a value to be obtained by the GMR sensor is disturbed by the magnetic field generated by the current flowing in the voice coil which amplitudes around the magnetic circuitry. Therefore, the position of the GMR sensor must be kept away from the voice coil. In the present embodiment, the first magnet (the magnet of the magnetic circuitry) is not used as in the conventional case, but a new mechanism in which a third magnet is newly installed is provided. It should be noted that the drawings referred to in the following description of the embodiments contain exaggerated representations in order to facilitate understanding of the disclosure, and do not represent the shape or scale of an actual product.

### Examples

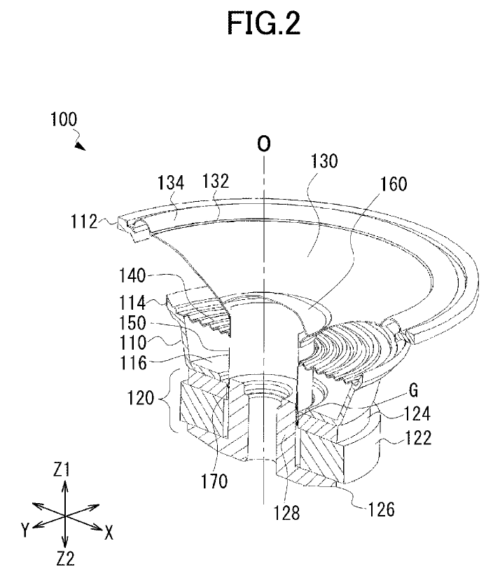

Next, an embodiment of the present disclosure will be described in detail with reference to the drawings. FIG. 2 is a perspective diagram illustrating a cross section of a loudspeaker according to an embodiment of the present disclosure. In FIG. 2, a Z1-Z2 direction is the front-rear direction of a loudspeaker 100, the Z1-direction is the front direction, and the Z2-direction is the rear direction. FIG. 2 also shows a central axis O extending in the front-rear direction (Z1-Z2 direction). The main part of the loudspeaker 100 has a substantially rotationally symmetric structure about the central axis O.

The loudspeaker 100 includes a frame 110 formed of a non-magnetic material or a magnetic material. The frame 110 has a tapered shape with a diameter gradually expanding toward the front, and magnetic circuitry 120 is fixed to the rear of the frame 110 by means such as adhesion or screwing.

The magnetic circuitry 120 includes a ring-shaped first magnet 122, as a driver, about the central axis O, a ring-shaped top plate (opposing yoke) 124 bonded to the front of the first magnet 122, a back plate (rear yoke) 126 bonded to the rear of the first magnet 122, and a center pole (center yoke) 128 positioned inside the first magnet 122 and the top plate 124 and extending forward from the back plate 126. The top plate 124, the back plate 126, and the center pole 128 are formed of a magnetic material.

The center pole 128 has a cylindrical shape. A magnetic gap G is formed along a circumference about the central axis O between the outer peripheral surface of the center pole 128 and the inner peripheral surface of the top plate 124. In the magnetic circuitry 120, a driving magnetic field generated by the first magnet 122 crosses the magnetic gap G from the top plate 124 and circles around the center pole 128 and the back plate 126.

A cone-shaped diaphragm 130 is provided inside the front part of the frame 110. A front end peripheral portion 112 of the frame 110 and an outer peripheral end 132 of the diaphragm 130 are bonded together through an elastically deformable edge 134. The edge 134 and the front end peripheral portion 112, and the edge 134 and the outer peripheral end 132 are fixed by an adhesive. An inner peripheral fixing portion 114 is formed on the inner surface of the middle part of the frame 110, and an end of an elastically deformable damper 140 having a corrugated cross-section is fixed to the inner peripheral fixing portion 114 by an adhesive. Magnetic circuitry 120 is attached to a rear end 116 of the frame 110.

A bobbin 150 is provided inside the frame 110. The bobbin 150 has a cylindrical shape with the central axis O as the center. The inner peripheral end of the diaphragm 130 is fixed to the outer peripheral surface of the bobbin 150 by an adhesive, and the end of the damper 140 is also fixed to the outer peripheral surface of the bobbin 150 by the adhesive. A dome-shaped cap 160 is provided at the center of the diaphragm 130, the cap 160 covers the front opening of the bobbin 150, and the peripheral edge of the cap 160 is fixed to the front surface of the diaphragm 130 by the adhesive. A voice coil 170 is wound around the outer peripheral surface of the rear end of the bobbin 150. The voice coil 170 is located within the magnetic gap G of the magnetic circuitry 120. The diaphragm 130 and the bobbin 150 are supported to be vibratable in the front-rear direction by elastic deformation of the edge 134 and the damper 140.

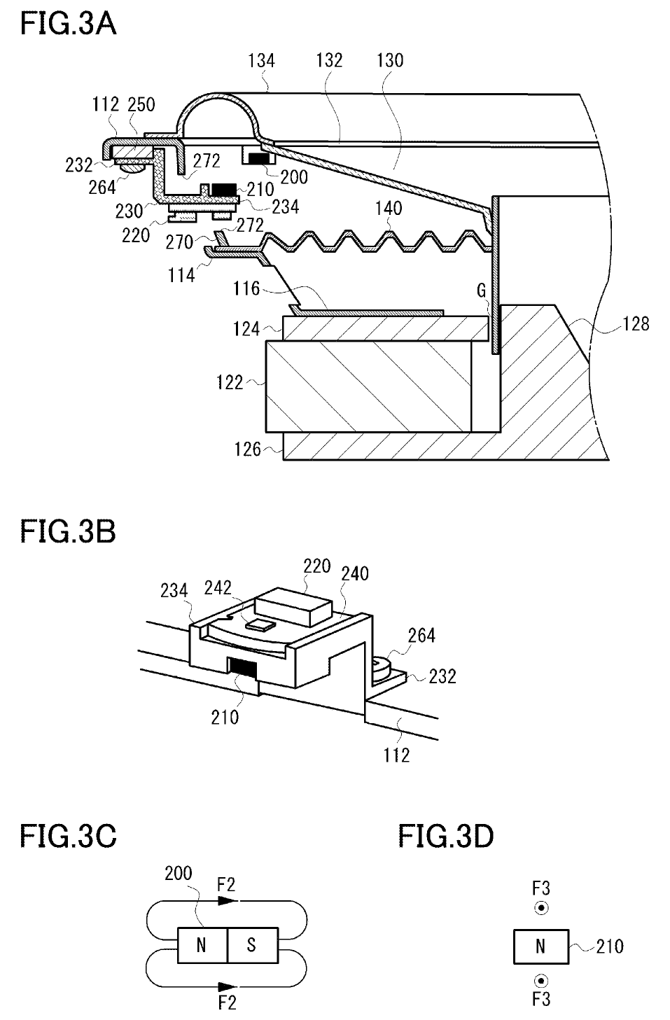

The loudspeaker 100 is further provided with a detector configured to detect movement or displacement of the diaphragm 130. FIG. 3A is an enlarged schematic cross-sectional diagram illustrating a detector portion, in the XZ plane including the central axis O.

The detector includes a holder 230 configured to integrally hold a second magnet 200, a third magnet 210, and a GMR sensor 220. FIG. 3A is a diagram illustrating an example in which the second magnet 200 and the holder 230 (i.e., the third magnet 210 and the magnetic (GMR) sensor 220) are located in the same XZ plane. When they are not located in the same XZ plane, for example, when the second magnet 200 is displaced in a Y-direction with respect to the holder 230, the position detection accuracy decreases by the amount of the displacement, such that it is desirable that the positions of the second magnet 200 and holder 230 coincide in the Y-direction. In addition, the second magnet 200 and holder 230 need to be in a positional relationship such that the magnetic field generated by the second magnet 200 can act on the GMR sensor 220.

The second magnet 200 is attached to the rear surface of one end of the diaphragm 130, as shown in FIG. 3A. The second magnet 200 is fixed to the rear surface of the outer peripheral end 132 of the diaphragm 130, for example. In other words, the second magnet 200 is fixed to a position where it vibrates together with the diaphragm 130 when the diaphragm 130 vibrates.

The shape of the second magnet 200 is not particularly limited, but when the second magnet 200 is rectangular, for example, the second magnet 200 is arranged such that a magnetization direction is horizontal. That is, as shown in FIG. 3C, when the second magnet 200 is viewed from the side, the second magnet 200 is arranged such that a magnetic field (lines of magnetic force) F2 directed from one end (N pole) of the second magnet 200 to the other end (S pole) includes a portion parallel to the XY plane.

A mounting method of the second magnet 200 is not particularly limited, but for example, the second magnet 200 is attached to the rear surface of the diaphragm 130 by an adhesive. As described in the following, after the diaphragm 130 and the magnetic circuitry 120 are assembled on the frame 110, the second magnet 200 is retrofitted into the frame via an opening 272 formed in a side wall 270 of the frame 110.

The holder 230 is a member configured to integrally hold the third magnet 210 and the GMR sensor 220. The holder 230 has, for example, a stepped shape, and one end 232 of the holder 230 is fixed by a screw 264 to a support 250 aligned with the flange-like front end peripheral portion 112 of the frame 110. A mounting portion 234 is supported by the end 232 via the stepped portion. The mounting portion 234 has a flat surface parallel to the XY plane, and the third magnet 210 is mounted on the upper surface of the mounting portion 234. The GMR sensor 220 is mounted on the rear surface of the mounting portion 234. The position of the mounting portion 234 is determined with respect to the second magnet 200 via the opening 272.

FIG. 3B is a perspective view of the holder 230 illustrated in FIG. 3A in an inverted state. In one embodiment, a printed wiring board 240 is mounted on the mounting portion 234 of the holder 230, and an electronic component 242 such as an IC chip for processing detection signals of the GMR sensor 220 and the GMR sensor 220 is mounted on the printed wiring board 240.

Although the shape of the third magnet 210 is not particularly limited, for example, when the third magnet 210 has a rectangular shape, the third magnet 210 is arranged such that the magnetization direction is horizontal in the same manner as the first magnet 122. However, the magnetization direction of the third magnet 210 must be different from the magnetization direction of the second magnet 200. For example, as shown in FIG. 3D, the magnetization direction of the third magnet 210 is perpendicular to the magnetization direction of the second magnet 200. A portion of a magnetic field (magnetic force line) F3 directed from one end (N pole) of the third magnet 210 to the other end (S pole), which is parallel to the XY plane, is perpendicular to the direction of the magnetic field F2. The direction of the magnetic field F3 of the third magnet 210 is not necessarily perpendicular to the direction of the magnetic field F2, and may be different from 90 degrees.

The GMR sensor 220 is held parallel to the XY plane on the holder 230, and detects the direction of the combined vector of the magnetic field from two directions. Here, the GMR sensor 220 detects the combined vector of the magnetic field based on the magnetic field F3 generated by the third magnet 210 positioned on a side facing the GMR sensor 220 and the magnetic field F2 generated by the second magnet 200 fixed to the rear surface of the diaphragm 130, thereby enabling detection of displacement of the diaphragm 130. When the diaphragm 130 vibrates, the relative position between the second magnet 200 and the GMR sensor 220 changes, and the magnitude and direction (vector) of the magnetic field F2 acting on the GMR sensor 220 change. In contrast to the above, since the relative position between the third magnet 210 and the GMR sensor 220 does not change, the magnetic field F3 acting on the GMR sensor 220 is substantially constant. Thus, the GMR sensor 220 detects an angular change of a vector obtained by combining the magnetic flux vector of the magnetic field F2 of the second magnet 200 and the magnetic flux vector of the magnetic field F3 of the third magnet 210, and calculates the displacement of the diaphragm 130 from this angular change. For example, the electronic component 242 mounted on a printed circuit board can receive a detection signal concerning the angular change of the combined vector from the GMR sensor 220, calculate the position of the diaphragm or positional displacement of the diaphragm from the detection signal, and feed a calculated result back to the amplifier.

As described above, in the present embodiment, by using the third magnet 210, restriction on a mounting position of the GMR sensor 220 is eliminated, and the second magnet 200, the third magnet 210, and the GMR sensor 220 can be respectively arranged at positions that improve ease of assembly and are less susceptible to electromagnetic influence (current magnetic field by the voice coil) by the loudspeaker operation. The GMR sensor 220 can detect the displacement of the diaphragm more accurately without being affected by the current magnetic field of the voice coil 170 by utilizing the magnetic field of the third magnet 210 which is installed at a position sufficiently distant from the first magnet 122 and the voice coil 170.

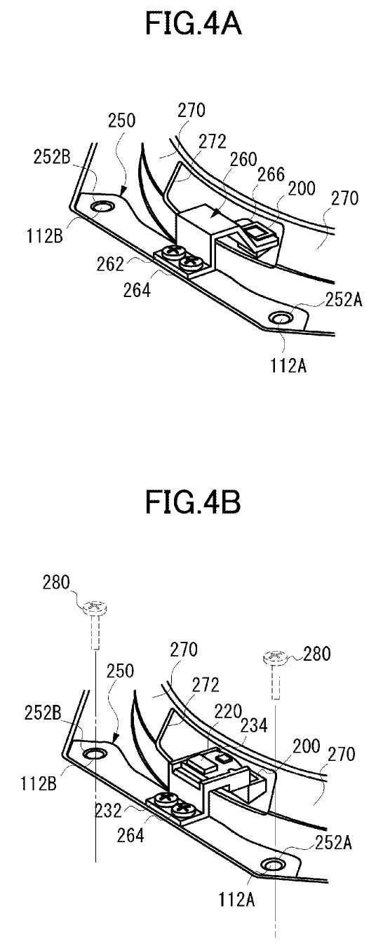

Next, a method of mounting the second magnet and the holder will be described. FIG. 4A is a diagram illustrating a method of mounting the second magnet 200 on the rear surface of the diaphragm. In the diagram, a rear surface side of the front end peripheral portion 112 of the frame 110 is illustrated.

Two circular mount holes 112A and 112B configured to mount the loudspeaker 100 at a position not shown in the drawing are formed in the front end peripheral portion 112. When the second magnet 200 is mounted to the diaphragm 130, a mounting member is used. The mounting member includes an elongated support 250 having a constant plate thickness and a positioning portion 260 connected to the support 250. Positioning through holes 252A and 252B are formed at both ends of the support 250 by burring. The through holes 252A and 252B are formed at the same interval and the same size as the mount holes 112A and 112B.

The positioning portion 260 is connected to a central portion of the support 250. The positioning portion 260 is a convex member having a raised middle portion, one end 262 is fixed to the support 250 by the screw 264, and a recess such as a notch for positioning the second magnet 200 is formed at the other end 266. The recess substantially coincides with the outer shape of the second magnet 200. A rectangular opening 272 for allowing access into the frame is formed in the side wall 270, at a midway point between the mount holes 112A and 112B, connected to the front end peripheral portion 112 of the frame 110.

The second magnet 200 is mounted as follows. First, the support 250 to which the positioning portion 260 is connected is prepared. Next, the support 250 is placed over on the front end peripheral portion 112 such that the through holes 252A and 252B of the support 250 coincide with the mount holes 112A and 112B of the frame 110. At this time, the other end 266 of the positioning portion 260 is positioned in the periphery of the rear surface of the diaphragm 130 through the opening 272 of the frame. Next, the second magnet 200 is positioned with respect to the diaphragm 130 by using the notch of the other end 266 of the positioning portion 260, and the positioned second magnet 200 is attached to the rear surface of the diaphragm 130 by using, for example, an adhesive. For example, an adhesive is previously applied to one surface of the second magnet 200, and the second magnet 200 is fixed by pressing the second magnet 200 against the back surface of the diaphragm 130 at the same time as positioning the second magnet. The second magnet 200 is attached to the diaphragm 130 in an already magnetized state. This is because when the second magnet 200 is magnetized after being attached to the diaphragm 130, the first magnet 122 is adversely affected. The attachment of the second magnet 200 and the magnetization process may be performed by a person or a machine. When the mounting of the second magnet 200 is completed, the support 250 is removed from the front end peripheral portion 112 of the frame 110.

Next, the support 250 to which the holder 230 is connected is prepared. That is, the end 232 of the holder 230 is fixed to the support 250 by the screw 264. The support 250 used for mounting the second magnet 200 may be used, or another support 250 may be prepared separately. Next, the support 250 is placed over on the front end peripheral portion 112 such that the through holes 252A and 252B of the support 250 coincide with the mount holes 112A and 112B of the frame 110. At this time, the mounting portion 234 is accurately positioned with respect to the second magnet 200 through the opening 272 of the frame. By using the support 250 used for positioning the second magnet 200, the holder 230 is accurately and readily positioned with respect to the second magnet 200. Next, with the mount holes 112A and 112B aligned with the through holes 252A and 252B, the loudspeaker 100 is mounted at a predetermined position by using, for example, screws 280.

When the second magnet is disposed inside the loudspeaker as in the conventional loudspeaker, the assembly process becomes difficult. However, the assemblability of the loudspeaker can be enhanced by disposing the second magnet 200 at a position where it is not appreciably affected by the current magnetic field of the voice coil and the second magnet 200 can be retrofitted from the frame window hole as in the loudspeaker of the present embodiment. In addition, by re-positioning and installing a component in which the GMR sensor 220 and the third magnet 210 are integrated by the holder 230 by using a portion (frame mount holes 112A and 112B, and support 250) used for positioning of the second magnet when the second magnet is installed, the variation in a magnetic-field detection amount due to assembly can be stabilized.

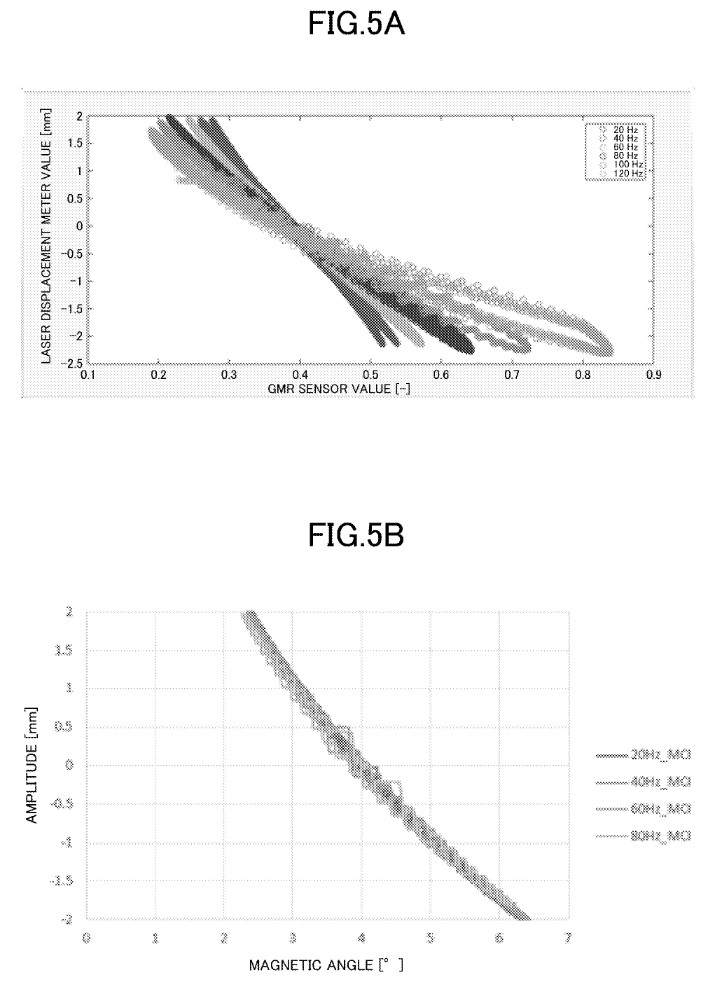

FIG. 5A is a graph illustrating the relationship between the displacement of the diaphragm and the magnetic angle in a conventional loudspeaker. FIG. 5B is a graph illustrating the relationship between the displacement of the diaphragm and the magnetic angle in the loudspeaker of the present embodiment. In the conventional loudspeaker, the relationship between the output value of the GMR sensor and the displacement of the diaphragm changes depending on the frequency of the audio signal, and it is difficult to accurately detect the displacement of the diaphragm. In contrast, in the loudspeaker of the present embodiment, the displacement of the diaphragm obtained from the output value of the GMR sensor is generally consistent even when the frequency of the audio signal changes, and thus, the displacement of the diaphragm can be accurately detected.

The specific shapes of the holder 230, the support 250, the positioning portion 260 and the like described in the above embodiment are only examples, and the present disclosure is not limited to these shapes. In addition, although the GMR sensor is exemplified as the magnetic sensor in the present embodiment, a tunnel magnetoresistance (TMR) sensor may also be used.

According to the present disclosure, since the magnetic field generated by the second magnet fixed to the rear surface of one end of the diaphragm acts on the magnetic detector, the magnetic field generated by the current flowing in the voice coil of the magnetic circuitry is not appreciably affected, and the displacement of the diaphragm can be accurately detected. Furthermore, since the second magnet and the holder are positioned by using a common positioning portion, a relative positional error of the second magnet, the third magnet, and the magnetic detector can be reduced, thereby enhancing the accuracy of detecting the displacement of the diaphragm. Furthermore, since the second magnet and the holder can be retrofitted, the assemblability of the loudspeaker can be facilitated.

Although the preferred embodiment of the present invention has been described in detail above, the present invention is not limited to a specific embodiment, and various changes and modifications are possible within the scope of the gist of the invention described in the claims.

What is claimed is:

1. A loudspeaker, comprising:
a diaphragm having a first end attached to a frame and a second end attached to a bobbin;
magnetic circuitry arranged in a vicinity of the bobbin;
a first magnet configured to vibrate the diaphragm based on a voice signal applied to a voice coil;
a second magnet fixed to a rear surface of the first end of the diaphragm;
a magnetic detector;
a third magnet; and
a holder configured to hold the magnetic detector and the third magnet, wherein in the loudspeaker,
the holder is fixed to the frame to be positioned with respect to the second magnet by using a positioning portion of the frame configured to fix the second magnet in place, and
the magnetic detector is configured to detect displacement of the diaphragm based on a first magnetic field generated by the second magnet and a second magnetic field generated by the third magnet in a direction different from the first magnetic field.

2. The loudspeaker according to claim 1, wherein
the second magnet is fixed to the rear surface of the first end of the diaphragm via an opening formed in the frame by using a mounting member that uses the positioning portion.

3. The loudspeaker according to claim 2, wherein
the positioning portion includes a plurality of mount holes formed in a flange portion of the frame for mounting the loudspeaker, and
the mounting member is positioned with respect to the plurality of mount holes.

4. The loudspeaker according to claim 3, wherein
the holder is fixed to the mounting member positioned with respect to the plurality of mount holes.

5. The loudspeaker according to claim 1, wherein
the magnetic detector includes a giant magnetoresistance sensor.

6. A method of manufacturing a loudspeaker, comprising:
attaching a diaphragm and magnetic circuitry to a frame, and then attaching a second magnet to a rear surface of a first end of the diaphragm by using a positioning portion of the frame; and
attaching a holder configured to hold a magnetic sensor and a third magnet to the frame by using the positioning portion such that the holder is positioned with respect to the second magnet, wherein, in the loudspeaker,
the first end of the diaphragm is attached to the frame and a second end of the diaphragm is attached to a bobbin,
the magnetic circuitry is arranged in a vicinity of the bobbin, and
the loudspeaker includes a first magnet configured to vibrate the diaphragm based on a voice signal applied to a voice coil.
